(19) United States
(12) Patent Application Publication
(10) Pub. No.: US 2008/0036241 A1
(43) Pub. Date: Feb. 14, 2008

(54) Vehicle body, chassis, and braking systems manufactured from conductive loaded resin-based materials

(75) Inventor: Thomas Aisenbrey, Littleton, CO (US)

Correspondence Address: DOUGLAS R. SCHNABEL, 316 HART STREET, ESSEXVILLE, MI, 48732, US

(73) Assignee: Integral Technologies, Inc.

(21) Appl. No.: 11/227,849

(22) Filed: Sep. 15, 2005

Related U.S. Application Data
(63) Continuation-in-part of application No. 10/877,092, filed on Jun. 25, 2004.
Application No. 10/877,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.
(60) Provisional application No. 60/609,928, filed on Sep. 15, 2004.
(60) Provisional application No. 60/610,476, filed on Sep. 16, 2004.

(51) Int. Cl. B60J 7/00

(52) U.S. Cl. 296/187.01

(57) ABSTRACT

Vehicle body, chassis, and braking components are formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are metals or conductive non-metals or metal plated non-metals. The micron conductive fibers may be metal fiber or metal plated fiber. Further, the metal plated fiber may be formed by plating metal onto a metal fiber or by plating metal onto a non-metal fiber. Any platable fiber may be used as the core for a non-metal fiber. Superconductor metals may also be used as micron conductive fibers and/or as metal plating onto fibers in the present invention.

### RELATED PATENT APPLICATIONS

This Patent Application claims priority to the U.S. Provisional Patent Application 60/609,928, filed on Sep. 15, 2004, and to the U.S. Provisional Patent Application 60/610,476, filed on Sep. 16, 2004, which are herein incorporated by reference in its entirety.

This Patent Application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, now issued as U.S. Pat. No. 6,870,516, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001, all of which are incorporated by reference in their entirety.

### BACKGROUND OF THE INVENTION

1). Field of the Invention

This invention relates to vehicle chassis, body, and braking systems and, more particularly, to vehicle chassis, body, and braking systems molded of conductive loaded resin-based materials comprising micron conductive powders, micron conductive fibers, or a combination thereof, substantially homogenized within a base resin when molded. This manufacturing process yields a conductive part or material usable within the EMF, thermal, acoustic, or electronic spectrum(s).

2). Description of the Prior Art

Traditional vehicle chassis and body systems have been manufactured from steel or aluminum. Recently, resin-based composites have been used to form chassis components and body sheeting. The difficulty in the prior art is the need to achieve the high strength, conductivity, and manufacturability of metal with the lower weight and corrosion resistance of resin-based material. The present invention presents a novel conductive loaded resin-based material that is applied to the fabrication of chassis and body components for various vehicles. This material provides exceptional strength, durability, and formability combined with electrical conductivity, electromagnetic and acoustic energy absorption and corrosion resistance.

As an additional consideration, some recent friction braking systems have utilized resin-based materials in the braking pads. Challenges in the design and manufacture of brake pads include durability, heat dissipation, static electricity control, and predictability. The present invention presents a novel conductive loaded resin-based material that is applied to the fabrication of brake pads. This material combines excellent strength, durability, and formability with electrical conductivity, static energy control, and corrosion resistance.

Several prior art inventions relate to U.S. Patent Publication U.S. 2003/0139518 A1 to Miyoshi et al teaches a resin composition which has an excellent balance of electrical conductivity and Dart impact strength at low temperatures, and excellent stiffness at high temperatures, thermal resistance, fluidity, and surface appearance for use in automotive parts such as a fender or side-door panel. U.S. Patent Publication U.S. 2003/0096103 A1 to Watanabe et al teaches a metal plate comprising a conductive plastic coated film and an electro deposition coated film which are laminated and coated at least on one surface thereof, for use as an outer plate part for car bodies and electrical appliances. U.S. Patent Publication U.S. 2003/0057402 A1 to Schneck teaches a paint able conductive resin coating for obscuring or hiding the imperfections caused by the weld seam in an automobile body comprising an epoxy resin and including a particulate of graphite, copper, silver, aluminum, iron, magnesium, turbostratic carbon, and alloys thereof. U.S. Pat. No. 5,041,471 to Brinzey teaches of friction materials with universal core of non-asbestos fibers for use in high performance brake pads for automotive racing. This invention teaches a mixture of aramid (Kevlar) fiber pulp, carbon fiber, ceramic fiber, and polybenzimidazole fiber to form 41% by weight of the total mixture added to the resin base and friction particles and friction modifiers.

U.S. Pat. No. 5,871,159 to Carlson et al teaches a fiber mixture for brake pads utilizing a static-free mixture of aramid or acrylic resin pulp or a mineral fiber pulp and other friction materials such as phenolic resin, particles made from cashew nut oil, natural or synthetic rubber in granular form, calcium carbonate, clay fiberglass, wollastonite, barites, magnesium oxide, or mineral wool. This invention also teaches the use of conductive fibers of steel, copper, or carbon added to the selected pulp mixture to give it anti-static properties and making the mixture less volatile when a solvent is added during the manufacturing process. U.S. Pat. No. 5,266,395 to Yamashita et al teaches a friction material for making brake pads suitable for preventing the generation of low frequency brake noise. This patent teaches the use of fibers of copper or a copper alloy and aramid fibers for reinforcement, and mica filler having a plane netlike crystal structure selected from the group of mica, talc, vermiculite, agalmatolite, kaolin, chlorite, sericite, and montmorillonite, and at least one hydroxide selected from the group of aluminum hydroxide, magnesium hydroxide, and iron hydroxide. U.S. Patent Publication U.S. 2003/0022961 A1 to Kusaka et al teaches a friction material useful for brake pads, brake linings, clutch facings, etc its method of manufacturing by mix-fibrillating all of the pulp fibers used in one step thereby increasing the evenness of mixture and increasing the overall quality. U.S. patent Publication U.S. 2002/0185346 A1 to Hays, J R teaches a brake pad with improved green performance utilizing a 2-layer pad with different wear resistance on each layer resulting in a shorter break-in time and helping to increase the lifetime of the pad.

### SUMMARY OF THE INVENTION

A principal object of the present invention is to provide an effective vehicle body or chassis component.

A further object of the present invention is to provide a vehicle body or chassis component molded of conductive loaded resin-based materials.

A further object of the present invention is to provide an effective vehicle brake system.

A further object of the present invention is to provide a vehicle brake system comprising conductive loaded resin-based materials.

A further object of the present invention is to provide a method to form a vehicle body or chassis component or brake system component.

A further object of the present invention is to provide vehicle components of reduced weight.

A further object of the present invention is to provide vehicle components of improved strength and impact performance.

A further object of the present invention is to provide vehicle components of large thermal and electrical conductivity.

A further object of the present invention is to provide vehicle components having excellent electromagnetic energy absorption.

A further object of the present invention is to provide vehicle components that are magnetic or magnetizable.

A further object of the present invention is to provide a structural material compatible with prepreg and/or wet lay-up manufacturing methodologies.

A yet further object of the present invention is to provide vehicle body or chassis component or brake system molded of conductive loaded resin-based material where the electrical or thermal characteristics can be altered or the visual characteristics can be altered by forming a metal layer over the conductive loaded resin-based material.

A yet further object of the present invention is to provide methods to fabricate a vehicle body or chassis component or brake system from a conductive loaded resin-based material incorporating various forms of the material.

A yet further object of the present invention is to provide a method to fabricate a vehicle body or chassis component or brake system vehicle body or chassis component or brake system from a conductive loaded resin-based material where the material is in the form of a laminate, cloth, or webbing.

A yet further object of the present invention is to provide a method to fabricate a vehicle body or chassis component wherein a prepreg laminate, cloth, or webbing of conductive loaded, resin-based material is applied to a structural frame.

In accordance with the objects of this invention, a transportation vehicle device is achieved. The device comprises a structural frame and a covering panel. The covering panel comprises a conductive loaded, resin-based material comprising micron conductive fiber in a base resin host.

Also in accordance with the objects of this invention, a braking device for a transportation vehicle is achieved. The device comprises a first structure fixably attached to a wheel of a vehicle such that the first structure rotates with the wheel. A pad comprises a conductive loaded, resin-based material comprising micron conductive fiber in a base resin host. The percent by weight of the micron conductive fiber is between 20% and 50% of the total weight of the conductive loaded resin-based material. A means to force is provide to force the pad into contact with the first structure during braking and to separate the pad from the first structure during non-braking.

Also in accordance with the objects of this invention, a method to form a component of a transportation vehicle device is achieved. The method comprises providing a conductive loaded, resin-based material comprising micron conductive fiber in a resin-based host. The conductive loaded, resin-based material is molded into a component of a transportation vehicle device.

### BRIEF DESCRIPTION OF THE DRAWINGS

In the accompanying drawings forming a material part of this description, there is shown:

FIG. 1 illustrates a first preferred embodiment of the present invention showing a military vehicle having various body and chassis components comprising a conductive loaded resin-based material.

FIG. 2 illustrates a second preferred embodiment of the present invention showing a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold a toy or toy component of a conductive loaded resin-based material.

FIG. 7 illustrates a second preferred embodiment of the present invention showing an armored vehicle having various body and chassis components comprising a conductive loaded resin-based material.

FIG. 8 illustrates a third preferred embodiment of the present invention showing an armored vehicle having various body and chassis components comprising a conductive loaded resin-based material.

FIG. 9 illustrates a fourth preferred embodiment of the present invention showing a quarter panel for a passenger vehicle comprising a conductive loaded resin-based material.

FIG. 10 illustrates a fifth preferred embodiment of the present invention showing a bumper for a passenger vehicle comprising a conductive loaded resin-based material.

FIG. 11 illustrates a sixth preferred embodiment of the present invention showing a door for a passenger vehicle comprising a conductive loaded resin-based material.

FIG. 12 illustrates a seventh preferred embodiment of the present invention showing a hood for a passenger vehicle comprising a conductive loaded resin-based material.

FIG. 13 illustrates an eighth preferred embodiment of the present invention showing an aircraft comprising a conductive loaded resin-based material.

FIG. 14 illustrates a ninth preferred embodiment of the present invention showing a vehicle disk braking system having components comprising a conductive loaded resin-based material.

FIG. 15 illustrates a tenth preferred embodiment of the present invention showing a vehicle drum braking system having components comprising a conductive loaded resin-based material.

FIGS. 16 and 17 illustrate an eleventh preferred embodiment of the present invention showing a disk brake pads comprising a conductive loaded resin-based material.

### DESCRIPTION OF THE PREFERRED EMBODIMENTS

This invention relates to vehicle chassis, body, and breaking systems molded of conductive loaded resin-based materials comprising micron conductive powders, micron conductive fibers, or a combination thereof, substantially homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are substantially homogenized within the resin during the molding process, providing the electrical, thermal, and/or acoustical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of chassis, body, and breaking systems fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the chassis, body, and breaking systems are substantially homogenized together using molding techniques and or methods such as injection molding, over-molding, insert molding, thermoset, protrusion, extrusion, calendaring, or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

In the conductive loaded resin-based material, electrons travel from point to point when under stress, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive loading concentration, that is, the separation between the conductive loading particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductive loaded resin-based material are altered when molded into a structure. A substantially homogenized conductive microstructure of delocalized valance electrons is created. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

The use of conductive loaded resin-based materials in the fabrication of chassis, body, and breaking systems significantly lowers the cost of materials and the design and manufacturing processes used to hold ease of close tolerances, by forming these materials into desired shapes and sizes. The chassis, body, and breaking systems can be manufactured into infinite shapes and sizes using conventional forming methods such as injection molding, over-molding, or extrusion, calendaring, or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are substantially homogenized together within the base resin, during the molding process, yielding an easy to produce low cost, electrically conductive, close tolerance manufactured part or circuit. The resulting molded article comprises a three dimensional, continuous network of conductive loading and polymer matrix. Exemplary micron conductive powders include carbons, graphites, amines or the like, and/or of metal powders such as nickel, copper, silver, aluminum, nichrome, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. Carbon nano-tubes may be added to the conductive loaded resin-based material. The addition of conductive powder to the micron conductive fiber loading may increase the surface conductivity of the molded part, particularly in areas where a skinning effect occurs during molding.

The micron conductive fibers may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, nichrome, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

The structural material may be any polymer resin or combination of polymer resins. Non-conductive resins or inherently conductive resins may be used as the structural material. Conjugated polymer resins, complex polymer resins, and/or inherently conductive resins may be used as the structural material. The dielectric properties of the resin-based material will have a direct effect upon the final electrical performance of the conductive loaded resin-based material. Many different dielectric properties are possible depending on the chemical makeup and/or arrangement, such as linking, cross-linking or the like, of the polymer, co-polymer, monomer, ter-polymer, or homo-polymer material. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion, or compression molding, or calendaring, to create desired shapes and sizes. The molded conductive loaded resin-based materials can also be stamped, cut or milled as desired to form create the desired shape form factor(s) of the chassis, body, and breaking systems. The doping composition and directionality associated with the micron conductors within the loaded base resins can affect the electrical and structural characteristics of the chassis, body, and breaking systems and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material may also be formed into a prepreg laminate, cloth, or webbing. A laminate, cloth, or webbing of the conductive loaded resin-based material is first impregnated with a resin-based material. In various embodiments, the conductive loaded resin-based material is dipped, coated, sprayed, and/or extruded with resin-based material to cause the laminate, cloth, or webbing to adhere together in a prepreg grouping that is easy to handle. This prepreg is placed, or laid up, onto a form and is then heated to form a permanent bond. In another embodiment, the prepreg is laid up onto the impregnating resin while the resin is “wet” or in a liquid, semi-liquid, or tacky state, prior to placement and is then cured by heating or other means. In another embodiment, the wet lay-up is performed by laminating the conductive loaded resin-based prepreg over a honeycomb structure. In yet another embodiment, a wet prepreg is formed by spraying, dipping, or coating the conductive loaded resin-based material laminate, cloth, or webbing in high temperature capable paint.

Carbon fiber and resin-based composites are found to display unpredictable points of failure. In carbon fiber systems there is no elongation of the structure. By comparison, in the present invention, the conductive loaded resin-based material displays greater strength in the direction of elongation. As a result a structure formed of the conductive loaded resin-based material of the present invention will hold together even if crushed while a comparable carbon fiber composite will break into pieces.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in chassis, body, and breaking systems applications as described herein.

The substantially homogeneous mixing of micron conductive fiber and/or micron conductive powder and base resin described in the present invention may also be described as doping. That is, the substantially homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder into a base resin.

As an additional and important feature of the present invention, the molded conductor loaded resin-based material exhibits excellent thermal dissipation characteristics. Therefore, chassis, body, and breaking systems manufactured from the molded conductor loaded resin-based material can provide added thermal dissipation capabilities to the application. For example, heat can be dissipated from electrical devices physically and/or electrically connected to chassis, body, and breaking systems of the present invention.

As a significant advantage of the present invention, chassis, body, and breaking systems constructed of the conductive loaded resin-based material can be easily interfaced to an electrical circuit or grounded. In one embodiment, a wire can be attached to a conductive loaded resin-based structure via a screw that is fastened to the structure. For example, a simple sheet-metal type, self tapping screw, when fastened to the material, can achieve excellent electrical connectivity via the conductive matrix of the conductive loaded resin-based material. To facilitate this approach a boss may be molded into the conductive loaded resin-based material to accommodate such a screw. Alternatively, if a solderable screw material, such as copper, is used, then a wire can be soldered to the screw that is embedded into the conductive loaded resin-based material. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the vehicle chassis, body, or breaking systems and a grounding wire.

Where a metal layer is formed over the surface of the conductive loaded resin-based material, any of several techniques may be used to form this metal layer. This metal layer may be used for visual enhancement of the molded conductive loaded resin-based material article or to otherwise alter performance properties. Well-known techniques, such as electroless metal plating, electro metal plating, sputtering, metal vapor deposition, metallic painting, or the like, may be applied to the formation of this metal layer. If metal plating is used, then the resin-based structural material of the conductive loaded, resin-based material is one that can be metal plated. There are many of the polymer resins that can be plated with metal layers. For example, GE Plastics, SUPEC, VALOX, ULTEM, CYCOLAC, UGIKRAL, STYRON, CYCOLOY are a few resin-based materials that can be metal plated. Electroless plating is typically a multiple-stage chemical process where, for example, a thin copper layer is first deposited to form a conductive layer. This conductive layer is then used as an electrode for the subsequent plating of a thicker metal layer.

A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

Another method to provide connectivity to the conductive loaded resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductive loaded resin-based material at the location of the applied solderable ink. Many other types of solderable inks can be used to provide this solderable surface onto the conductive loaded resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductive loaded resin-based material may be formed of the present invention to create a magnetic or magnetizable form of the material. Ferromagnetic micron conductive fibers and/or ferromagnetic conductive powders are mixed with the base resin. Ferrite materials and/or rare earth magnetic materials are added as a conductive loading to the base resin. With the substantially homogeneous mixing of the ferromagnetic micron conductive fibers and/or micron conductive powders, the ferromagnetic conductive loaded resin-based material is able to produce an excellent low cost, low weight magnetize-able item. The magnets and magnetic devices of the present invention can be magnetized during or after the molding process. The magnetic strength of the magnets and magnetic devices can be varied by adjusting the amount of ferromagnetic micron conductive fibers and/or ferromagnetic micron conductive powders that are incorporated with the base resin. By increasing the amount of the ferromagnetic doping, the strength of the magnet or magnetic devices is increased. The substantially homogenous mixing of the conductive fiber network allows for a substantial amount of fiber to be added to the base resin without causing the structural integrity of the item to decline. The ferromagnetic conductive loaded resin-based magnets display the excellent physical properties of the base resin, including flexibility, moldability, strength, and resistance to environmental corrosion, along with excellent magnetic ability. In addition, the unique ferromagnetic conductive loaded resin-based material facilitates formation of items that exhibit excellent thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fiber to cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductive loaded resin-based material may be magnetized, after molding, by exposing the molded article to a strong magnetic field. Alternatively, a strong magnetic field may be used to magnetize the ferromagnetic conductive loaded resin-based material during the molding process.

The ferromagnetic conductive loading is in the form of fiber, powder, or a combination of fiber and powder. The micron conductive powder may be metal fiber or metal plated fiber. If metal plated fiber is used, then the core fiber is a platable material and may be metal or non-metal. Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials. A ferromagnetic conductive loading may be combined with a non-ferromagnetic conductive loading to form a conductive loaded resin-based material that combines excellent conductive qualities with magnetic capabilities.

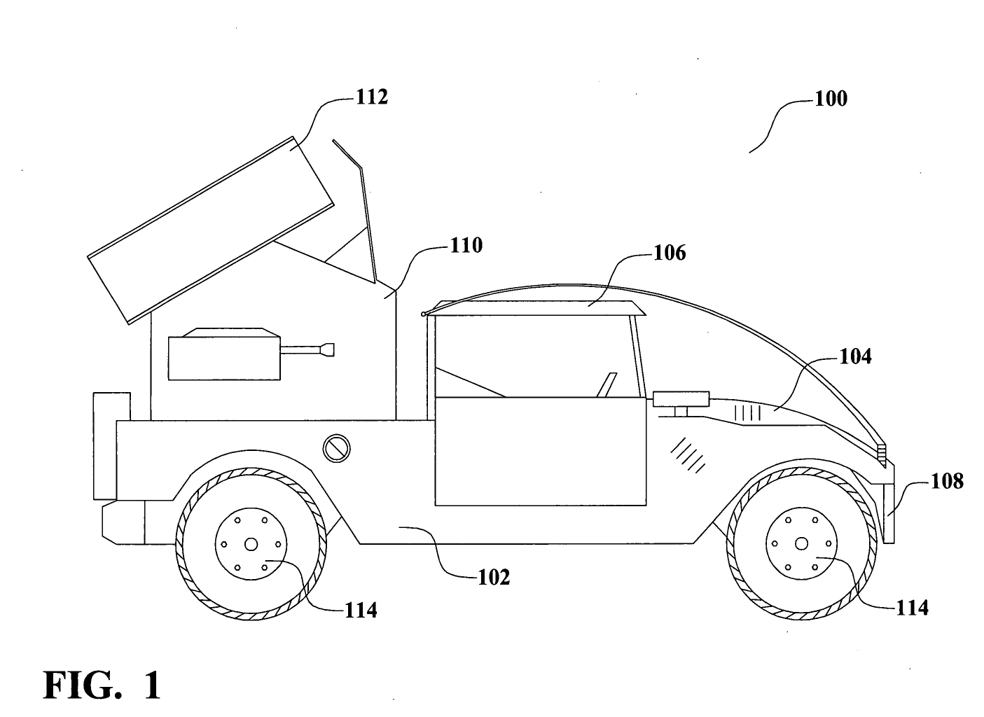

Referring now to FIG. 1, a first preferred embodiment of the present invention is illustrated. The embodiment shows a typical all-terrain military vehicle 100 where any, any combination, or all of the body and chassis components of, for example, side panels 102, hood 104, bumper 108, roof 106, wheels 114, rocket launcher panels 110, and rocket launcher covers 112 comprise the conductive loaded resin-based material of the present invention. In one embodiment, the body and chassis components entirely comprise the conductive loaded resin-based material. In another embodiment, the body and chassis components comprise a structural layer of steel or other hardened components with an outer layer of the conductive loaded resin-based material affixed thereon.

By fabricating the components of the conductive loaded resin-based material, a vehicle 100 with a very small radar profile is derived. The conductive loaded resin-based material of the present invention comprises a network of conductive fibers and, optionally, conductive powders in a polymer matrix. This material exhibits excellent absorption of RF energy across a wide bandwidth. As a result, the vehicle 100 reflects very little RF energy back to a radar detection system. The vehicle 100 is therefore much harder to detect using radar. As a further advantage, the conductive loaded resin-based material provides a significant weight reduction over metal sheeting. Conductive loaded resin-based material can be used in areas of the vehicle 100 that are less critical to vehicle armor protection. As a result, the steel and other armoring materials can be concentrated in areas of maximum vehicle and/or occupant protection. Alternately, a reduced weight vehicle 100 is derived resulting in greater vehicle performance and range of operation.

The vehicle components of the present invention differ substantially from prior art composite materials in several ways. First, in the prior art, carbon fiber or glass fiber (fiber glass) are typically combined with a resin-based material to form vehicle panels, etc. In the present invention, however, metal fibers are substantially homogeneously mixed into the resin-based matrix. The resulting composite material is found to be stronger and more resistance to cracking than comparable carbon fiber composites due to the ductility of the metal fiber. In addition, in the working range of fiber doping, the conductive loaded resin-based material exhibits a higher thermal and electrical conductivity, due the network of metal fibers, than a carbon fiber composite. Further, the conductive loaded, resin-based material of the present invention displays much greater ability to absorb electromagnetic energy.

Embodiments such as described above are derived in several ways. Where an all conductive loaded resin-based component is form, this is easily molded by, for example, injection molding. Second, where an outer layer, or skin, of the conductive loaded resin-based material is formed onto a structural member, such as a previously stamped metal panel, then this outer layer is easily formed by over molding the conductive loaded resin-based material onto the panel. In another embodiment, the conductive loaded resin-based material is in applied to metal panels, and the like, in the form of a layered fabric. If the base resin of the conductive loaded resin-based material is one that is useful for dissipating bullet energy, such as polyparaphenylene terephthalamide, then the conductive loaded resin-based material provides armor reinforcement in addition to radar shielding. In another embodiment, the conductive loaded resin-based material is formed into a prepreg laminate, cloth, or webbing comprising conductive loaded resin-based material that is impregnated with additional resin-based material. In various embodiments, the conductive loaded resin-based material is dipped, coated, sprayed, and/or extruded with the resin-based material to cause the laminate, cloth, or webbing to adhere together in a prepreg grouping that is easy to handle. This prepreg is placed, or laid up, onto the structural members of the vehicle component and is then heated to form a permanent bond. In another embodiment, the prepreg is laid up onto the impregnating resin while the resin is still wet and is then cured by heating or other means. In another embodiment, the wet lay-up is performed by laminating the conductive loaded resin-based prepreg over a honeycomb structure. In yet another embodiment, a wet prepreg is formed by spraying, dipping, or coating the conductive loaded resin-based material laminate, cloth, or webbing in high temperature capable paint.

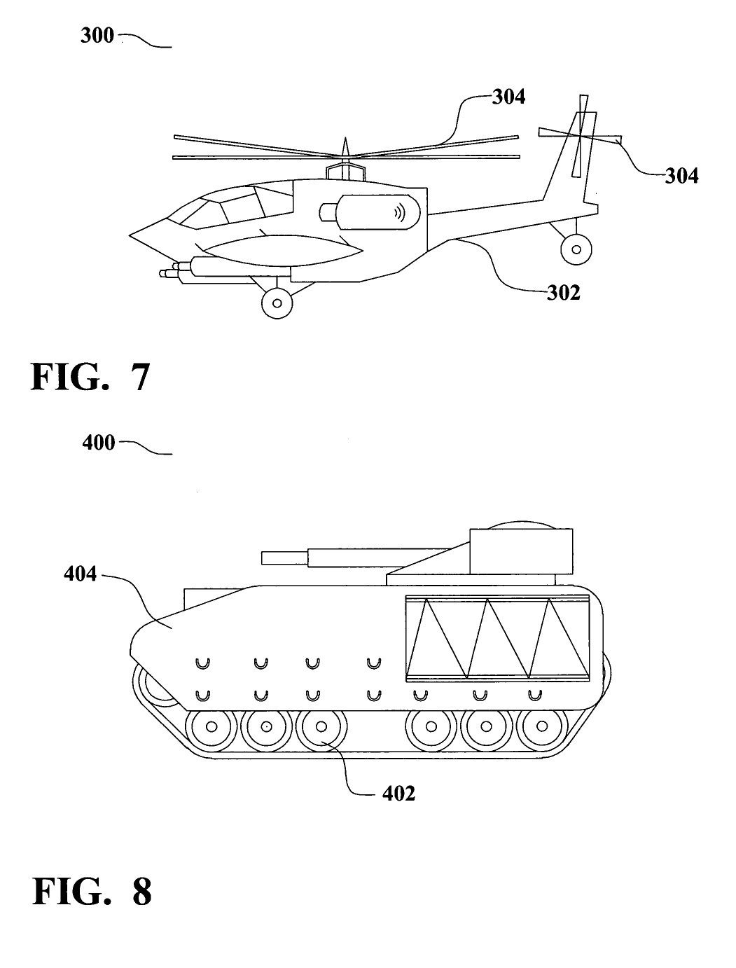

Referring now to FIG. 7 a second preferred embodiment of the present invention is illustrated. The embodiment shows a typical military helicopter 300, wherein the outer body and rotors/blades 304, comprise the conductive loaded resin-based material of the present invention. In one embodiment, helicopter components are formed entirely of the conductive loaded resin-based material. In another embodiment, components are composites formed, in part of metals, such as aluminum, or from resin-based honey combs, that are over-molded with a layer of the conductive loaded resin-based material. The above-described advantages in reduced EM emissions, reduced weight, and improved performance are, again, realized.

Referring now to FIG. 8, a third preferred embodiment of the present invention is illustrated. The embodiment shows an armored vehicle 400, wherein the wheels 402 and the exterior body 404, either comprises entirely the conductive loaded resin-based material or is covered with an outer layer, or skin, of the conductive loaded resin-based material of the present invention. The conductive loaded resin-based material sheathing provides several important advantages to the vehicle 400. First, the conductive loaded resin-based material sheathing reduces the RF emissions from the tank 400 to thereby make the vehicle 400 difficult to detect with radar. Second, the conductive loaded resin-based material is exhibits excellent heat transfer properties and aids in removing heat from the vehicle engine, transmission, and firing systems. Third, the advantages in reduced electromagnetic energy emission and in better heat transfer are realized with a material that is significantly lighter than steel or other metal materials.

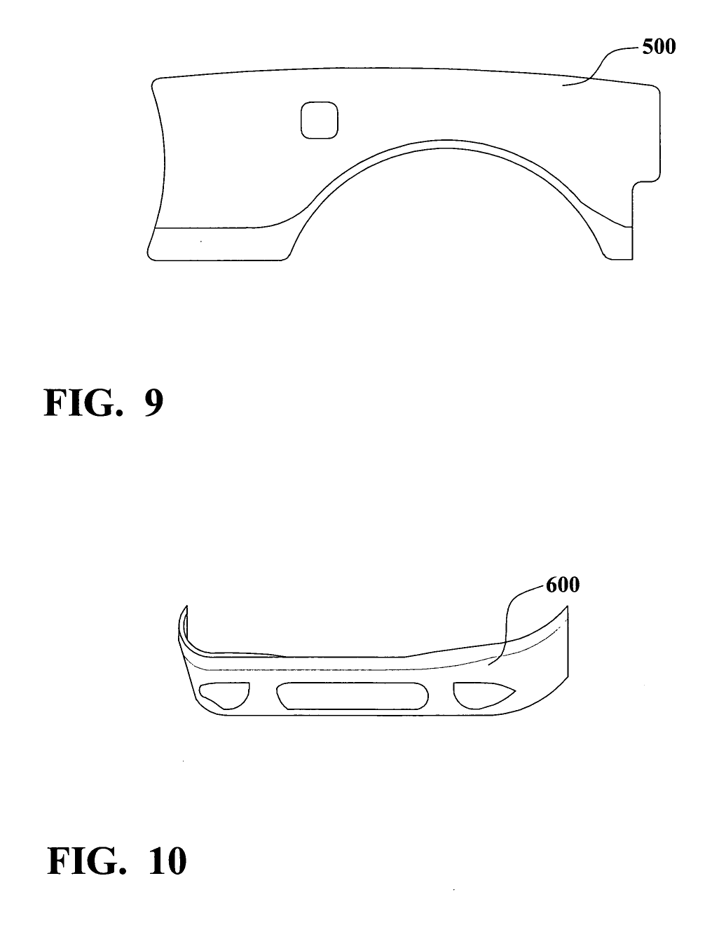

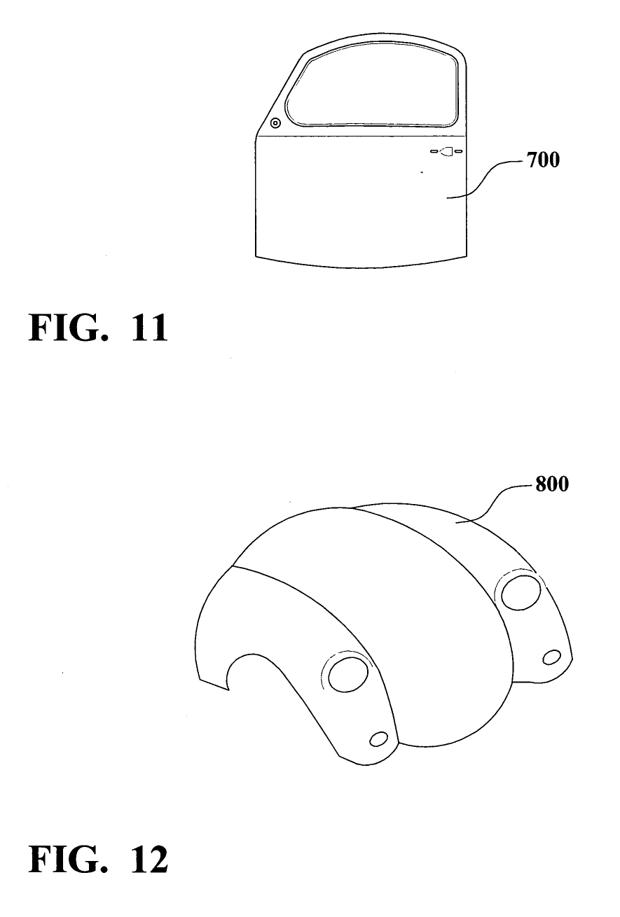

Referring now to FIG. 9, a fourth preferred embodiment of the present invention is illustrated. A rear quarter panel 500 comprising the conductive loaded resin-based material of the present invention is illustrated. Referring now to FIG. 10, a fifth preferred embodiment of the present invention shows a bumper 600 comprising the conductive loaded resin-based material of the present invention. Referring now to FIG. 11, a sixth preferred embodiment of the present invention is illustrated. A door 700 comprising the conductive loaded resin-based material of the present invention is illustrated. Referring now to FIG. 12, a seventh preferred embodiment of the present invention shows a hood 800 comprising the conductive loaded resin-based material of the present invention. The conductive loaded resin-based body components offer the advantages of reduced weight and reduced manufacturing cost. In addition, a strong and corrosion-free vehicle body material is achieved while retaining electrostatic paintability. A further advantage of the conductive loaded resin-based automotive body components of the present invention is the absorption of electromagnetic energy both from the vehicle (EM emission) and into the vehicle (EM interference).

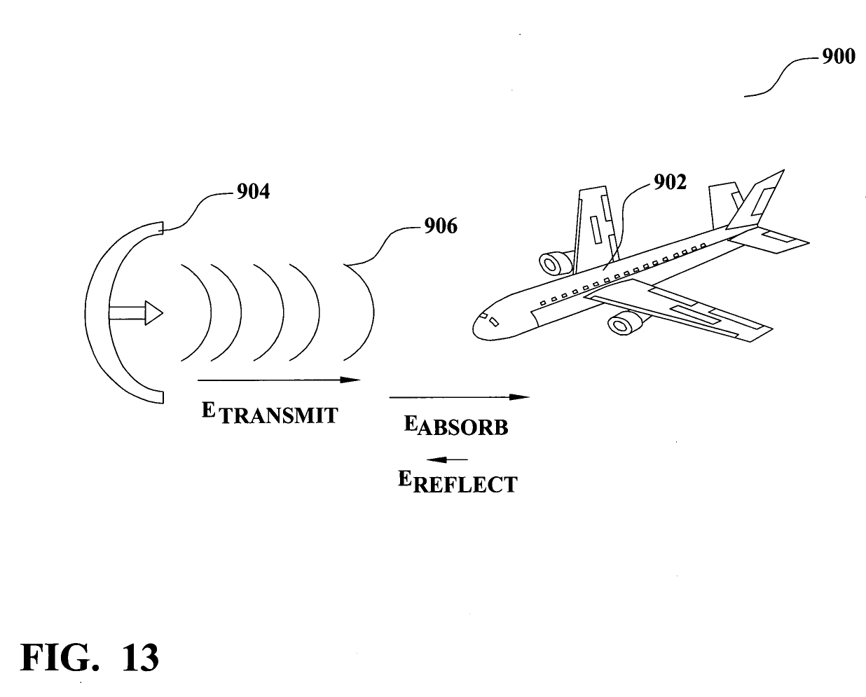

Referring now to FIG. 13, an eighth preferred embodiment 900 of the present invention is illustrated. In this case, the skin and/or structural materials of an aircraft 902 comprise the conductive loaded resin-based material according to the present invention. Radar detection systems 904 emit RF energy 906 and then measure the RF energy returning from any objects, such as aircraft, in the radar 904 field of view. A typical prior art aircraft, comprising an aluminum skin, will reflect a large amount of the incident RF energy 906 from the radar 904. As a result, it is relatively easy for a modern radar detection system 904 to detect a prior art aircraft. In the art of radar detection, this effect is called a large radar footprint. By comparison, an aircraft 902 with a skin and/or structural components comprising the conductive loaded resin-based material of the present invention will possess a conductive resin lattice structure that maximizes absorption of incident RF energy 906 from the radar 904. As a result, it is relatively difficult for the radar detection system 904 to detect the aircraft 902. Therefore, a relatively small radar footprint can be achieved using the material of the present invention.

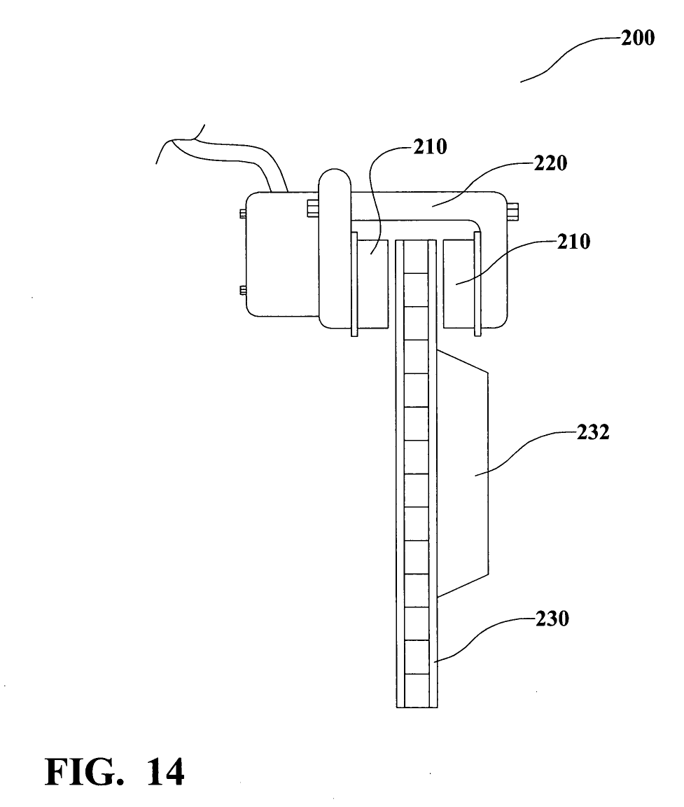

Referring now to FIGS. 14-17, preferred embodiments of vehicle brake systems comprising the conductive loaded, resin-based material of the present invention are illustrated. In particular, FIG. 14 illustrates a ninth preferred embodiment of the present invention. A disk braking device system 200 is illustrated. As is known in the art, a disk brake system 200 includes brake pads 210, brake calipers 220, and the disk or rotor 230. The brake pads 210 are mounted to the calipers 220. The disk 230 is fixably attached to the vehicle wheel, not shown, such that the disk 230 rotates while the vehicle is in motion. When braking pressure is requested, the calipers 220 force the brake pads 210 against the outer surfaces of the disk 230 thus causing the disk and the vehicle to decelerate. Otherwise, the calipers 230 allow the pads 210 to be separated from the disk 230. In one preferred embodiment, the brake pads 210 comprise conductive loaded resin-based material of the present invention. The brake pad materials are selected in order to provide appropriate coefficients of static friction and dynamic friction. The materials are further selected to provide superior wear and fade resistance. It is important that the materials and fabrication technique result in brake pads 210 which provide effective braking against the rotor 230 without creating excessive wear on the contact surfaces of the rotor.

In other embodiments of the present invention, friction material and braking devices are formed of conductive loaded resin-based material. The term “friction material and braking devices” as used herein refers to and includes brake pads, brake linings, brake blocks, brake shoes, and other friction devices for vehicle braking systems. Additional embodiments of “friction material and braking devices” comprising conductive loaded resin-based material include brake disks, rotors, clutch components such as clutch plates, and brake drums. The friction material and braking devices of the present invention are used in vehicular applications. Particular examples of automotive/motor vehicle braking devices are presented herein. However it is understood that the present invention also applies to friction material and braking devices for all types of vehicles including motor vehicles, trains, bicycles, motorcycles, and the like.

In one preferred embodiment, the resin used as the base resin host for the conductive loaded resin-based material of the present invention is selected from a group of high melting temperature thermoplastic resins. In an alternate embodiment, the base resin host is selected from a group of thermosetting plastics. In each embodiment of the present invention, an effective braking pad, disk, and/or drum is achieved with a conductive material weighing in the range of between about 20% and about 50% of the total weight of the combined base resin and conductive material and without further abrasive or other filler compounds. In one embodiment, the braking device relies only on the friction generation and heat dissipation of the conductive loaded resin-based material without any addition loading or fillers. However, additional loading or filler materials may be added of chemical having composition, size, and shape selected in order to provide the additional wear, fade-resistance, temperature range, and frictional properties for each particular application. In addition to the conductive fibers and/or conductive powders, other components including frictional additives may be included in certain embodiments of the present invention. Frictional additives include, but are not limited to, nonconductive fibers, fiberglass, mineral particles, cellulose, powders, carbon, and the like.

In one embodiment, the contact surface of the friction material and braking device of the present invention is altered after molding and prior to use in the vehicle. Such alteration may include, but is not limited to, coating, scorching, burnishing, laser treatment, and/or flame treatment. Such alterations are performed when they are deemed necessary based on the particular materials selected, the initial fabrication technique, and the particular vehicle application. In a more preferred embodiment, no such “break-in” treatment is required. Rather, the desired static and dynamic friction coefficients are achieved by proper material selection and fabrication technique.

In another embodiment, the brake systems integrated magnetic or magnetizable capabilities through the use of ferromagnetic conductive loading in the conductive loaded resin-based material. In one embodiment, a magnetic strip or pattern of a ferromagnetic loaded resin-based material is molded into the disk or drum. Such a magnetic component can be used for speed sensing or fault detection.

In an alternate embodiment again shown in FIG. 14, both the brake pads 210 and the brake disk 230 comprise conductive loaded resin-based material of the present invention. The brake disk 230 is essentially rigid. In one preferred embodiment, the disk 230 comprises a metal interior hub portion 232 over-molded with conductive loaded resin-based material in the region which contacts the brake pads 210. In each embodiment, the conductive loaded resin-based material provides cost and weight savings advantages over conventional materials. The conductive loaded resin-based material of the present invention also provides excellent thermal conductivity. This high thermal conductivity is very beneficial in dissipating heat away from the disk 230 during braking, thus reducing wear and increasing longevity of both the brake pads 210 and the disk 230.

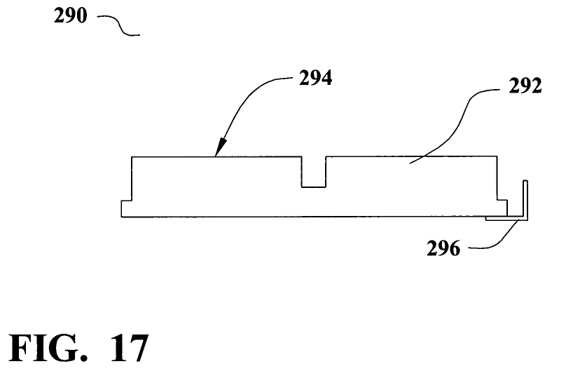

Referring now to FIGS. 16 and 17, eleventh and twelfth embodiments, respectively, of the present invention are illustrated. Disk brake pads 280 and 290 are shown in side view. Referring particularly to FIG. 16, the brake pad 280 comprise conductive loaded resin-based material 282 forming the friction side 288 and mounted and/or over-molded onto a metal back-plate 284. An optional metal wear detector plate 286 may be used to signal, via squeaking, when the pad 282 is substantially worn away. Referring now to FIG. 17, the pad 290 comprises the conductive loaded resin-based material 292 forming both the friction side 294 and the back plate. The optional metal wear detector plate 296 is shown.

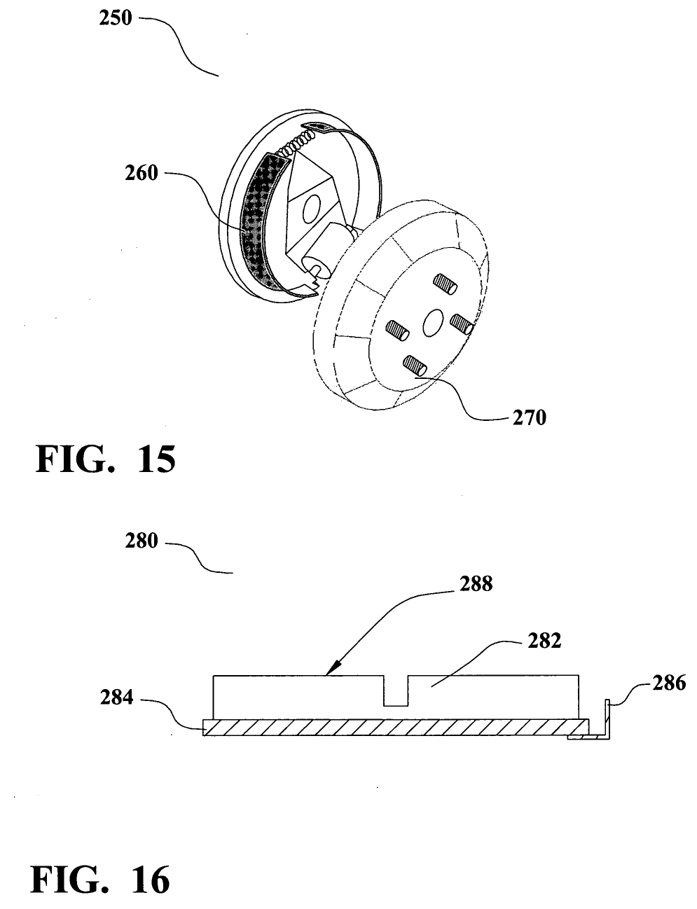

Referring particularly now to FIG. 15, a tenth preferred embodiment of the present invention is illustrated. A drum brake system 250 is shown. As is well known in the art, the drum brake system 250 comprises the brake drum 270, and the brake shoes 260. In this case, the brake drum 270 is fixably attached to the vehicle wheel, not shown, such that drum 270 rotates with the wheel. When braking is requested, the brake forces the brake pads, or shoes 260, radially outward to contact the interior surface of the brake drum 270. At other times, the brake mechanism maintains a gap between the shoes 260 and the drum 270. The contact between the brake shoes 260 and brake drum 270 causes friction between the contact surfaces which in turn causes the vehicle to decelerate.

In one preferred embodiment, the brake shoes 260 comprise conductive loaded resin-based material of the present invention. The brake shoe materials are selected in order to provide appropriate coefficients of static friction and dynamic friction. The materials are further selected to provide superior wear and fade resistance. It is important that the materials and fabrication technique result in brake shoes 260 which provide effective braking against the drum 270 without creating excessive wear on the contact surfaces of the drum.

In an alternate embodiment, both the brake shoes 260 and the brake drum 270 comprise conductive loaded resin-based material of the present invention. The brake drum 270 is essentially rigid. In one preferred embodiment, the drum 270 comprises a metal interior hub portion 272 over-molded with conductive loaded resin-based material in the region which contacts the brake shoes 260. In each embodiment, the conductive loaded resin-based material provides cost and weight savings advantages over conventional materials. The conductive loaded resin-based material of the present invention also provides excellent thermal conductivity. This high thermal conductivity is very beneficial in dissipating heat away from the drum 270 during braking, thus reducing wear and increasing longevity of both the brake shoes 260 and the drum 270.

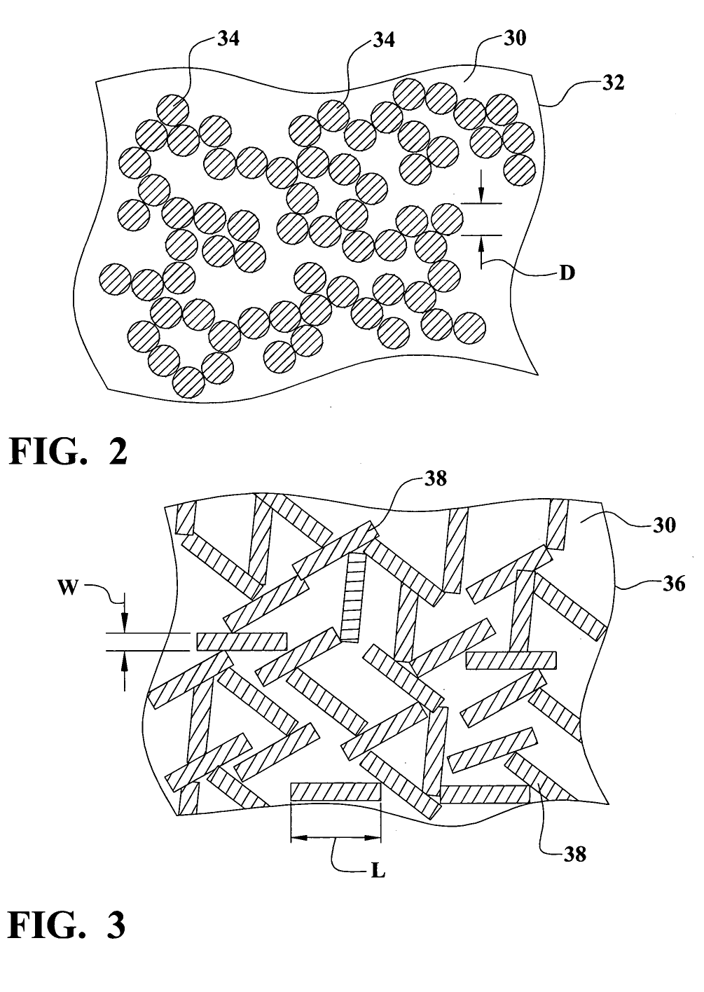

The conductive loaded resin-based material of the present invention typically comprises a micron powder(s) of conductor particles and/or in combination of micron fiber(s) substantially homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The micron conductive fibers 38 may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, nichrome, and rhodium, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

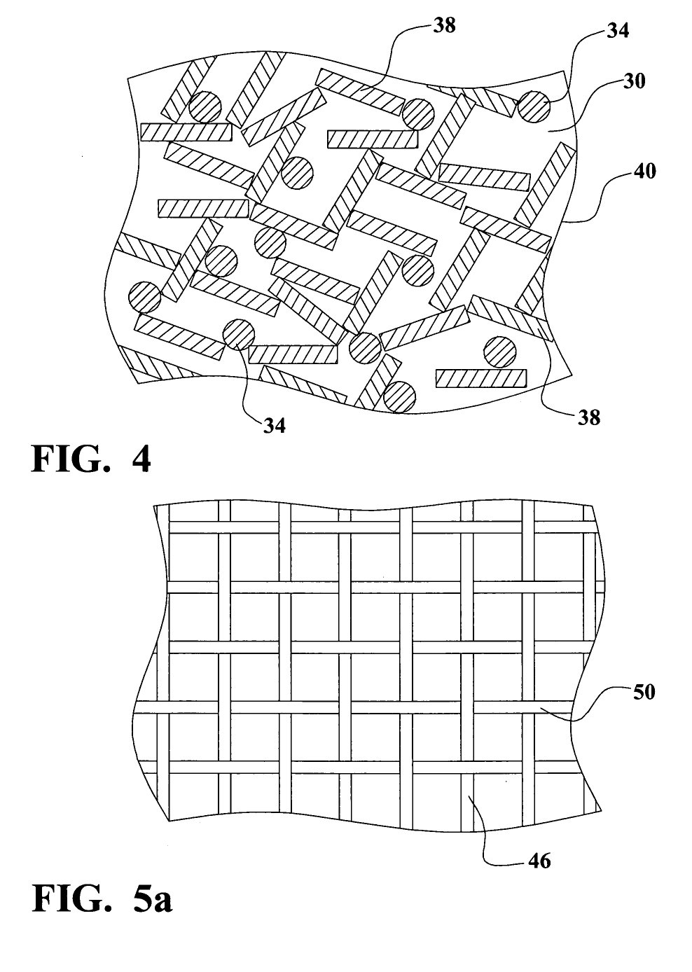

These conductor particles and/or fibers are substantially homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 6-12 micron in diameter and lengths of 4-6 mm and comprising, by weight, about 30% of the total weight of the conductive loaded resin-based material will produce a very highly conductive parameter, efficient within any EMF, thermal, acoustic, or electronic spectrum. Referring now to FIG. 4, another preferred embodiment of the present invention is illustrated where the conductive materials comprise a combination of both conductive powders 34 and micron conductive fibers 38 substantially homogenized together within the resin base 30 during a molding process.

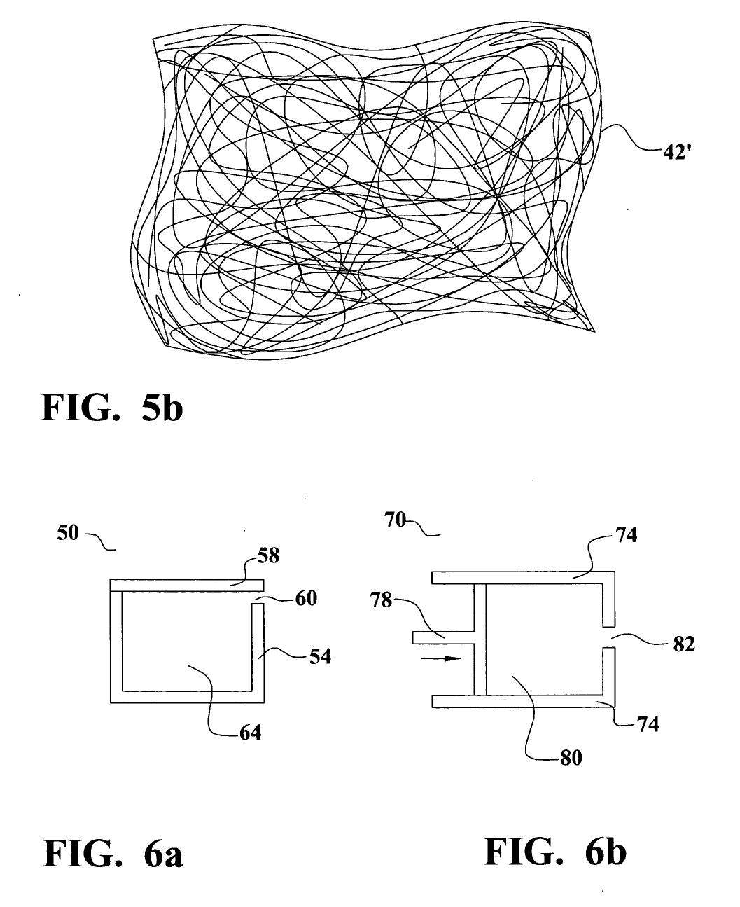

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

Vehicle chassis, body, or breaking systems formed from conductive loaded resin-based materials can be formed or molded in a number of different ways including injection molding, extrusion, calendaring, or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the substantially homogenized conductive material cures by thermal reaction. The upper portion 58 and lower portion 54 of the mold are then separated or parted and the devices are removed.

FIG. 6b shows a simplified schematic diagram of an extruder 70 for forming devices using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. Effective vehicle body or chassis components are achieved. The vehicle body or chassis components are molded of conductive loaded resin-based materials. Effective vehicle brake systems comprising conductive loaded resin-based materials are also achieved. Methods to form a vehicle body or chassis component or brake system component are achieved. Vehicle body or chassis components or brake systems are molded of conductive loaded resin-based material. The electrical or thermal characteristics can be altered or the visual characteristics can be altered by forming a metal layer over the conductive loaded resin-based material. Vehicle components of reduced weight, improved strength and impact performance, large thermal and electrical conductivity, electromagnetic energy absorption, electrostatic dissipation capability, and magnetic capability are realized. Vehicle structural materials compatible with prepreg and/or wet lay-up manufacturing methodology are achieved.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

What is claimed is:

1. A transportation vehicle device comprising:
a structural frame; and
a covering panel comprising a conductive loaded, resin-based material comprising micron conductive fiber in a base resin host.

2. The device according to claim 1 wherein the percent by weight of said micron conductive fiber is between about 20% and about 50% of the total weight of said conductive loaded resin-based material.

3. The device according to claim 1 further comprising micron conductive powder.

4. The device according to claim 1 wherein said micron conductive fiber is metal.

5. The device according to claim 1 wherein said micron conductive fiber comprises an inner core with an outer metal layer.

6. The device according to claim 1 wherein said covering panel is a hood, door, quarter panel, bumper, or cover.

7. The device according to claim 1 wherein said covering panel is molded to said structural frame.

8. The device according to claim 1 wherein said structural frame is a plurality of resin-based honey combs.

9. The device according to claim 1 wherein said conductive loaded, resin-based material is plated with a metal layer.

10. A braking device for a transportation vehicle, said device comprising:
a first structure fixably attached to a wheel of a vehicle such that said first structure rotates with said wheel;
a pad comprising a conductive loaded, resin-based material comprising micron conductive fiber in a base resin host wherein the percent by weight of said micron conductive fiber is between 20% and 50% of the total weight of said conductive loaded resin-based material; and
a means to force said pad into contact with said first structure during braking and to separate said pad from said first structure during non-braking.

11. The device according to claim 10 wherein said micron conductive fiber is stainless steel.

12. The device according to claim 10 further comprising micron conductive powder.

13. The device according to claim 10 wherein said first structure comprises said conductive loaded, resin-based material.

14. The device according to claim 10 wherein said first structure is a flat disk.

15. The device according to claim 10 wherein said first structure is a drum.

16. The device according to claim 10 further comprising a magnetic strip or pattern of a ferromagnetic loaded, resin-based material.

17. A method to form a component of a transportation vehicle device, said method comprising:
providing a conductive loaded, resin-based material comprising micron conductive fiber in a resin-based host; and
molding said conductive loaded, resin-based material into a component of a transportation vehicle device.

18. The method according to claim 17 wherein the percent by weight of said micron conductive fiber is between about 20% and about 50% of the total weight of said conductive loaded resin-based material.

19. The method according to claim 17 wherein further comprising micron conductive powder.

20. The method according to claim 17 wherein said micron conductive fiber is metal.

21. The method according to claim 17 wherein said micron conductive fiber comprises an inner core with an outer metal layer.

22. The method according to claim 17 wherein said component is a hood, door, quarter panel, bumper, or cover.

23. The method according to claim 17 wherein said component is a brake pad, disk, or drum.

24. The method according to claim 17 further comprising providing a structural frame and wherein said conductive loaded, resin-based material is molded onto said structural frame.

25. The method according to claim 24 wherein said structural frame is a plurality of resin-based honey combs.

26. The method according to claim 17 wherein said conductive loaded, resin-based material is plated with a metal layer.

27. The method according to claim 17 wherein said step of molding comprises:
injecting said conductive loaded, resin-based material into a mold;
curing said conductive loaded, resin-based material; and
removing said conductive fastening device from said mold.

28. The method according to claim 17 wherein said step of molding comprises:
loading said conductive loaded, resin-based material into a chamber;
extruding said conductive loaded, resin-based material out of said chamber through a shaping outlet; and
curing said conductive loaded, resin-based material to form said conductive fastening device.

29. The method according to claim 17 wherein said step of molding comprises:
forming said conductive loaded, resin-based material into a prepreg laminate, cloth, or webbing;
placing said prepreg laminate, cloth, or webbing onto a structural frame; and
heating said prepreg laminate, cloth, or webbing to form a permanent bond.

30. The method according to claim 29 wherein base resin of said conductive loaded, resin-based material is in a liquid, semi-liquid, or tacky state prior to said step of placing.
